(19) United States
(12) Patent Application Publication
(10) Pub. No.: US 2024/0143975 A1
(43) Pub. Date: May 2, 2024

(54) NEURAL NETWORK FEATURE EXTRACTOR FOR ACTOR-CRITIC REINFORCEMENT LEARNING MODELS

(71) Applicant: Robert Bosch GmbH, Stuttgart (DE)

(72) Inventors: Christoph KROENER, Freiberg am Neckar (DE); Jared EVANS, Sunnyvale, CA (US)

(21) Appl. No.: 17/979,054

(22) Filed: Nov. 2, 2022

(51) Int. Cl. G06N 3/04; G06N 3/08

(52) U.S. Cl. CPC G06N 3/0454; G06N 3/08

(57) ABSTRACT

Systems and methods of optimizing a charging of a vehicle battery are disclosed. Using one or more electronic battery sensors, observable battery state data is determined regarding the charging of the battery. A neural network feature extractor extracts features from preceding vehicle battery state information. A reinforcement learning model, such as an actor-critic model, includes an actor model configured to produce an output associated with a charge command to charge the battery, and a critic model configured to output a predicted reward. The reinforcement learning model is trained based on the vehicle battery state information and the extracted features. This includes updating weights of the actor model to maximize the predicted reward output by the critic model, and updating weights of the feature extractor and weights of the critic model to minimize a difference between the predicted reward and health-based rewards received from charging the battery. Hidden battery state information is approximated based on the extracted features.

### CROSS-REFERENCE TO RELATED APPLICATIONS

The present disclosure is related to the following applications which are filed on the same day as this application, and which are incorporated by reference herein in their entirety:
U.S. patent application Ser. No. ______, titled REINFORCEMENT LEARNING FOR CONTINUED LEARNING OF OPTIMAL BATTERY CHARGING, attorney docket number 097182-00205
U.S. patent application Ser. No. ______, titled SMOOTHED REWARD SYSTEM TRANSFER FOR ACTOR-CRITIC REINFORCEMENT LEARNING MODELS, attorney docket number 097182-00206

### TECHNICAL FIELD

The present disclosure relates to a neural network feature extractor for actor-critic reinforcement learning models.

### BACKGROUND

Reinforcement learning is an area of machine learning concerned with how intelligent agents ought to take actions in an environment in order to maximize the notion of cumulative reward. Reinforcement learning usually involves time series information. The agent determines how to act in the future based on the current state and discounted rewards. The way in which a state is reached can often result in hidden variables that the observable variables do not fully characterize. This is known as a partially-observable Markov decision process (POMDP). These hidden variable may not be directly knowable.

### SUMMARY

In an embodiment, a method of optimizing a charging of a vehicle battery using reinforcement learning includes: via one or more electronic battery sensors, determining observable battery state data associated with charging of a vehicle battery, wherein vehicle battery state information includes the observable battery state data and hidden battery state information; via a sequence-processing neural network feature extractor (SPNNFE), extracting features from preceding vehicle battery state information; providing an actor-critic model including (i) an actor model configured to produce an output associated with a charge command to charge the vehicle battery, and (ii) a critic model configured to output a predicted reward; and training the actor-critic model based on (i) the vehicle battery state information, and (ii) the extracted features. The training includes: updating weights of the actor model to maximize the predicted reward output by the critic model, and updating weights of the SPNNFE and weights of the critic model to minimize a difference between (i) the predicted reward output by the critic model and (ii) health-based rewards received from charging of the vehicle battery. The method includes approximating at least some of the hidden battery state information based on the extracted features in order to optimize charging of the vehicle battery.

In an embodiment, a system for optimizing a charging of a vehicle battery using reinforcement learning includes one or more processors, and memory storing instructions that, when executed by the one or more processors, cause the one or more processors to: via one or more electronic battery sensors, determine observable battery state data associated with charging of a vehicle battery, wherein vehicle battery state information includes the observable battery state data and hidden battery state information; via a sequence-processing neural network feature extractor (SPNNFE), extract features from preceding vehicle battery state information; provide an actor-critic model including (i) an actor model configured to produce an output associated with a charge command to charge the vehicle battery, and (i) a critic model configured to output a predicted reward; and train the actor-critic model based on (i) the vehicle battery state information, and (ii) the extracted features. The actor-critic model is trained via: updating weights of the actor model to maximize the predicted reward output by the critic model, and updating weights of the SPNNFE and weights of the critic model to minimize a difference between (i) the predicted reward output by the critic model and (ii) health-based rewards received from charging of the vehicle battery. Further, at least some of the hidden battery state information is approximated based on the extracted features in order to optimize charging of the vehicle battery.

In an embodiment, a method of approximating hidden state information of a reinforcement learning model includes: via one or more electronic sensors, determining observable state information, wherein state information includes the observable state information and hidden state information; via a recurrent neural network feature extractor (RRNFE), extracting features from preceding state information; providing an actor-critic model including (i) an actor model configured to produce an output associated with a control system, and (ii) a critic model configured to output a predicted reward; and training the actor-critic model based on the state information and the extracted features. The training includes: updating weights of the actor model to maximize the predicted reward output by the critic model, and updating weights of the RRNFE and weights of the critic model to minimize a difference between (i) the predicted reward output by the critic model and (ii) rewards associated with the output for the control system. The actor-critic model is used to approximate at least some of the hidden state information based on the extracted features.

### BRIEF DESCRIPTION OF THE DRAWINGS

FIG. 1 shows a system for training a neural network, according to an embodiment.

FIG. 2 illustrates an exemplary component diagram of a system for optimizing charging of a vehicle battery, according to an embodiment.

FIG. 3 illustrates the framework of an actor-critic model used for offline training, according to an embodiment.

FIG. 4 illustrates the framework of an actor-critic model used during operation (e.g., non-simulation, on-field) according to an embodiment.

FIG. 5 shows a schematic of a deep neural network with nodes in an input layer, multiple hidden layers, and an output layer, according to an embodiment.

FIG. 6 shows a schematic of a system implementing a recurrent neural network feature extractor for actor-critic reinforcement learning models, according to an embodiment.

FIG. 7 shows a method of optimizing a charging of a vehicle battery using reinforcement learning with the feature extractor, according to an embodiment.

FIG. 8 illustrates the framework of an actor-critic model used during an acting phase, according to an embodiment.

FIG. 9 illustrates the framework of an actor-critic model used during a learning or training phase, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Reinforcement learning is an area of machine learning concerned with how intelligent agents ought to take actions in an environment in order to maximize the notion of cumulative reward. Reinforcement learning usually involves time series information. The critic learns the expected rewards and the actor learns a policy intended to maximize those rewards. The agent determines how to act in the future based on the current state and discounted rewards. The way in which a state is reached can often result in hidden variables that the observable variables do not fully characterize. These hidden variable may not be directly knowable.

Reinforcement learning can be applied to things that can be modeled in principle, for example in Markov decision processes (MDP). Once class of MDP is a partially-observable MDP (POMDP). Here, the state space is split into the observable space and the hidden space. This can create difficult situations to learn from because the same observable state space would have different hidden states that govern behavior. So, while models can detect that something indeed is happening during the training, the decision is based on these hidden states and thus information is undetectable. In other words, the models can understand that as inputs change, the outputs vary, but the hidden states that also impact the output are not fully understood.

In one example, in video-based reinforcement learning, a pre-trained convolutional neural network (CNN) is often used as a feature extractor to allow for details within an image to be tracked. For example, features of a detected object (e.g., its class, speed, orientation, etc.) can be extracted via a trained CNN for reinforcement learning. However, some information (e.g., private information, temporal information, etc.) can be encoded or otherwise undetectable by the model, and thus much of the information is not fully understood.

According to various embodiments disclosed herein, an actor-critic model can use preceding time steps in an MDP, and feed this into a recurrent neural network (RNN) feature extractor to learn features which are an attempt to model some of these hidden parameters. By extracting these features, the model can get a more complete state space that would be known otherwise. This improves the machine learning overall because in addition to the observable state, the model can now be provided with extracted features which are a projection of the hidden state space.

During backpropagation to train the model, the loss from the critic is fed back through the RNN feature extractor to update the feature extractor weights; the feature extractor weights are not updated during the actor model backpropagation. The critic network adapts and alters weights based on the extracted features, and that same feature information is fed into the overall model.

The feature extractor disclosed herein can encode some of the variables hidden from the observable state in a POMDP by feeding in many of the preceding states. Using this additional information then as part of the state can result in an improved policy due to the additional information. This effectively renders some of the unobservable information in the POMDP observable in a way that the reward system alone cannot capture.

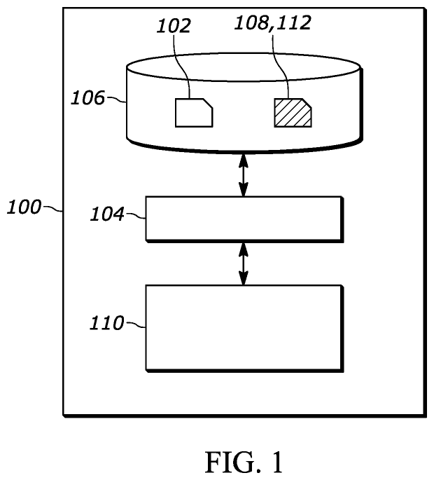

Referring to the Figures, reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The backpropagation and/or forward propagation can continue until the models achieve a predetermined performance level (e.g., 100% agreement with the outcomes associated with the training data), or convergence. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The system 100 may further comprise an output interface for outputting a data representation 112 of the trained neural network, this data may also be referred to as trained model data or trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data parameters 112 may be stored separately from the data representation 108 defining the ‘untrained’ neural network. In some embodiments, the output interface may be separate from the data storage interface 104, but may in general be of a type as described above for the data storage interface 104.

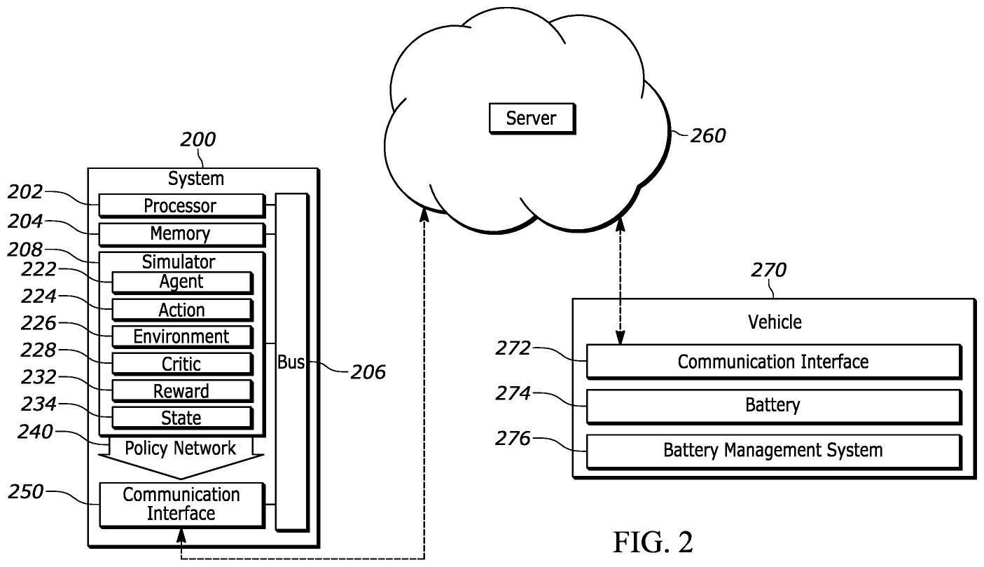

The structure of the system 100 is one example of a system that may be utilized to train the models described herein. Additional structure for operating and training the machine-learning models is shown in FIG. 2.

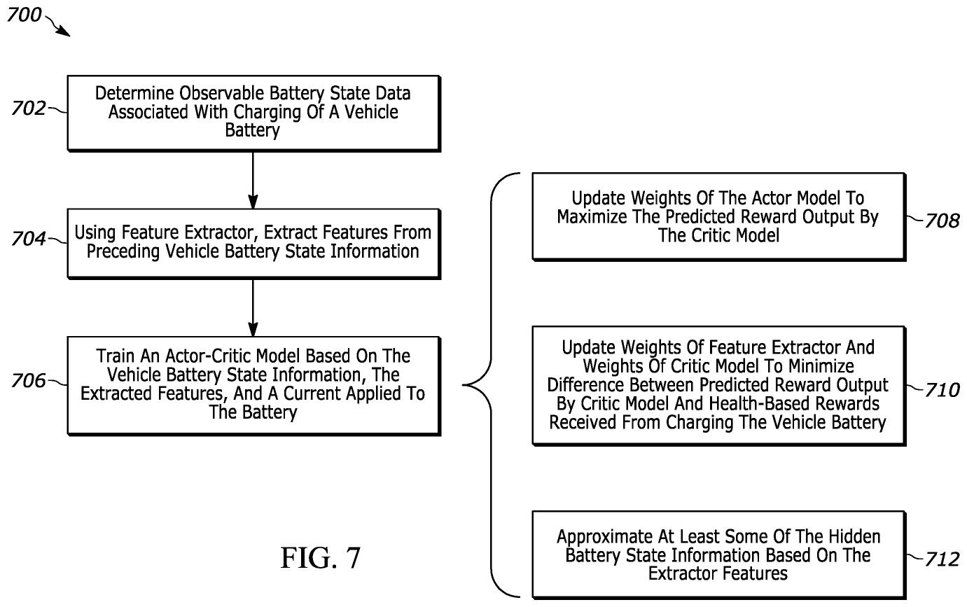

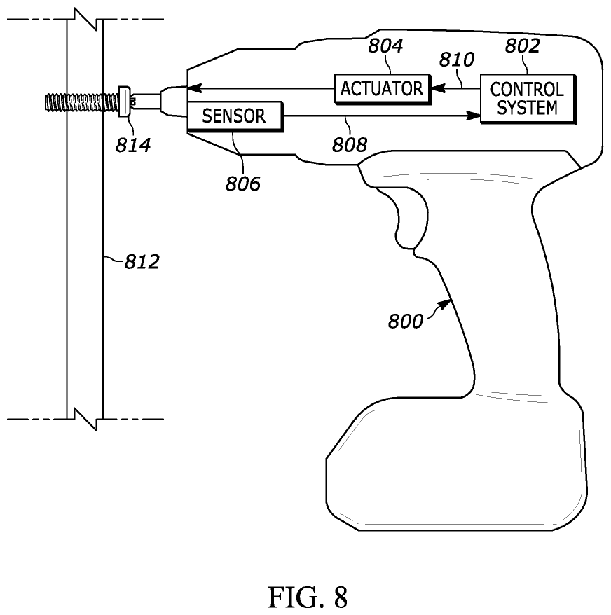

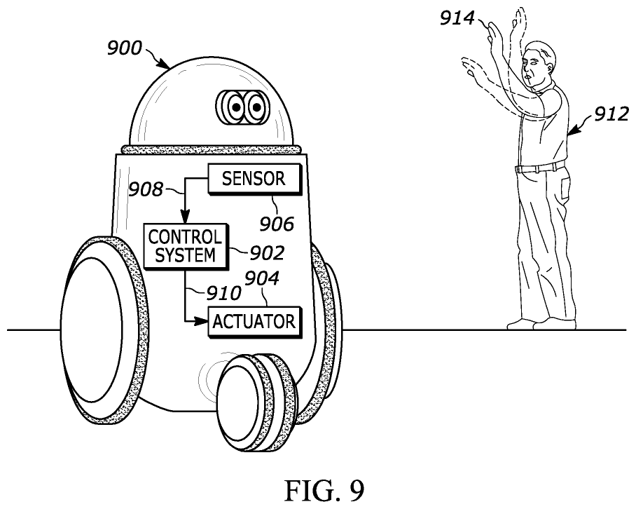

FIG. 2 is an exemplary component diagram of a system 200 for optimizing a charging of a vehicle battery based on both simulation data and field data. As the system 200 relies on both simulation data and field data (e.g., actual production vehicles in use), the system 200 can be referred to as a hybrid system incorporating hybrid models. In non-hybrid embodiments, the system can rely on simulation data without the need for field data. In general, the system 200 may include a processor 202, a memory 204, a bus 206, and a simulator 208. The simulator 208 may be implemented via the processor 202 and the memory 204. In an embodiment, the simulator 208 may simulate or perform simulation associated with one or more agents 222, taking one or more actions 224, within a simulation environment 226, where one or more critics 228 interpret or evaluate one or more of the actions 224 taken by one or more of the agents 222 to determine one or more rewards 232 and one or more states 234 resulting from the actions taken. In an embodiment, the agent 222 takes, as input, environment output state 234 and reward 232, and then selects an action 224 to take; the action is a subdivision of the agent—they are similar in that both take a state as input and output an action, but they are different in that the actor does not see the reward (even as a loss) only seeing the critic outputs for a loss. FIGS. 7 and 8 show flow charts of this embodiment in which the actor-critic model is operating in an acting phase (e.g., where the model is FIG. 8) and in a learning phase (FIG. 9). Additional context of these figures is provided elsewhere herein.

The processor 202 is programmed to process signals and perform general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

The processor 202 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, graphics processing units (GPUs) tensor processing units (TPUs), vision processing units (VPUs), or any other devices that manipulate signals (analog or digital) based on computer-executable instructions residing in memory 204. In some examples, the processor 202 may be a system on a chip that integrates functionality of a central processing unit, the memory 204, a network interface, and input/output interfaces into a single integrated device.

Upon execution by processor 202, the computer-executable instructions residing in the memory 204 may cause an associated control system to implement one or more of the machine-learning algorithms and/or methodologies as disclosed herein. The memory 204 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium (e.g., memory 204) having computer readable program instructions thereon for causing the processor 202 to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

The processes, methods, or algorithms can be embodied in whole or in part using suitable hardware components, such as Application Specific Integrated Circuits (ASICs), Field-Programmable Gate Arrays (FPGAs), state machines, GPUs, controllers or other hardware components or devices, or a combination of hardware, software and firmware components.

The bus 206 can refer to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. In embodiments in which the battery is a vehicle battery, the bus may be a vehicle bus that interconnects components inside a vehicle using protocols such as Media Oriented Systems Transport (MOST), Controller Area network (CAN), Local Interconnect Network (LIN), among others.

The simulator 208 or the processor 202 may generate a policy network 240. In particular, the reinforcement learning disclosed herein, such as the actor-critic models, can include a deep deterministic policy gradient (DDPG), more specifically a twin delayed deep deterministic policy gradient (TD3), in order to construct a charging policy to optimize the battery charging. This can include a reward system design to minimize the charging time and degradation of the battery. The reward system is the combination of rewards given by the environment and any post-processing performed by the agent, such as the discount factor, that affect the quantitative assignment of the loss function. TD3 methods in particular allow for off-policy and offline learning, enabling the disclosed hybrid approach. The policy network 240 may be stored on the memory 204 of the system 100 for the reinforcement learning.

The system 200 may further include a communication interface 250 which enables the policy network 240 to be transmitted to other devices, such as a server 260, which may include a reinforcement learning database 262. In this way, the policy network 240 generated by the system 200 for reinforcement learning may be stored on a database of the server 160. The communication interface 250 may be a network interface device that is configured to provide communication with external systems and devices (e.g., server 260). For example, the communication interface 250 may include a wired and/or wireless Ethernet interface as defined by Institute of Electrical and Electronics Engineers (IEEE) 802.11 family of standards. The communication interface 250 may include a cellular communication interface for communicating with a cellular network (e.g., 3G, 4G, 5G). The communication interface 250 may be further configured to provide a communication interface to an external network (e.g., world-wide web or Internet) or cloud, including server 260.

The server 260 may then propagate the policy network 240 to one or more vehicles 270. While only one vehicle 270 is shown, it should be understood that more than one vehicle 270 may be provided in the system. Each of the vehicles can be either a simulation vehicle (e.g., used in lab simulations) or a field vehicle (e.g., vehicles used by consumers in actual driving and/or charging events). In hybrid embodiments, the system includes both simulation vehicle(s) and a field vehicle(s). In non-hybrid embodiments, the vehicle 270 may include a simulation vehicle without a field vehicle. The vehicle 270 may be any moving vehicle that is capable of carrying one or more human occupants, such as a car, truck, van, minivan, SUV, motorcycle, scooter, boat, personal watercraft, and aircraft. In some scenarios, the vehicle includes one or more engines. The vehicle 270 may be equipped with a vehicle communication interface 272 configured to communicate with the server 260 in similar fashion as the communication interface 260. The vehicle 270 may also include a battery 274 that is configured to at least partially propel the vehicle. Therefore, the term “vehicle” may refer to an electric vehicle (EV) that is powered entirely or partially by one or more electric motors powered by the electric battery 274. The EV may include battery electric vehicles (BEV) and plug-in hybrid electric vehicles (PHEV), wherein the battery 274 propels the vehicle 270. Additionally, the term “vehicle” may refer to an autonomous vehicle and/or self-driving vehicle powered by any form of energy. The autonomous vehicle may or may not carry one or more human occupants.

The vehicle 270 also includes a battery management system 276 configured to manage, operate, and control the battery 274. In particular, the policy network 240 output from the system 200 and sent to the vehicle 270 via the server 260 can command the battery management system 276 to control the battery 274 to charge or discharge in a particular manner. Therefore, the battery management system 276 may refer to associated processors and memory (such as those described above) configured to charge the battery 274 according to stored or modified instructions. The battery management system 276 may also include various battery state sensors configured to determine the characteristics of the battery 274, such as voltage, temperature, current, amplitude, resistance, and the like. These determined signals can, when processed, determine a state of health of the battery 274.

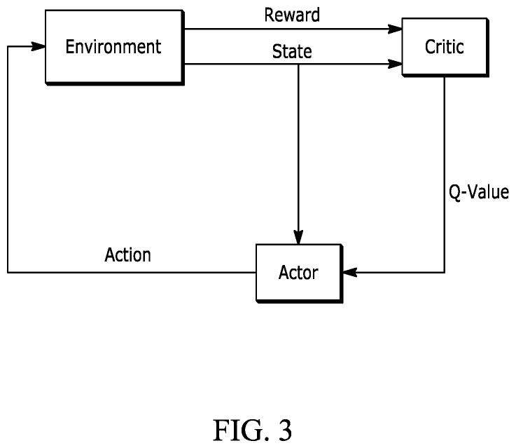

FIG. 3 is a high-level block diagram of an actor-critic reinforcement learning model 300, according to an embodiment. In general, the actor-critic model 300 can be used for offline training of the reinforcement model. The environment can refer to the battery in simulation or a simulated vehicle. The term “agent” can include the actor and the critic together, along with the replay buffer and feature extractor. Here, the actor may take the action in the environment (e.g., the battery). The action can refer to the policy described above, e.g., a command sent to the battery management system regarding a commanded battery charge current. This may be interpreted, by the critic, as the reward or penalty and a representation of the state, which may be then fed back into the agent. The agent may interact with the environment by taking the action at a discrete time step. At each time step, the agent may receive an observation which may include the reward. The agent may select one action from a set of available actions, which results in a new state and a new reward for a subsequent time step. The goal of the agent is generally to collect the greatest amount of rewards possible.

Q-learning is a form of reinforcement learning which uses Q-values (also called action values) to iteratively improve the behavior of the learning agent. “Q” refers to the function that the algorithm computes—the expected rewards for an action taken in a given state. Q-values can be defined for states and actions on the environment, and represent an estimation of how good it is to take the action at the state.

The diagram of FIG. 3 shows the general flow of state observations and reward signals between the algorithm and the environment (e.g., the battery), the critic's update and its value estimate, which is used by the policy in its policy gradient updates. Discrete control action output is computed by the actor, given the state observation. The critic, computes a Q-value loss based on the state and the action.

An action-critic algorithm relies on using two neural networks to accomplish different tasks: the actor A, which takes as input the state, s, and outputs the action, a; A(s)=a, and the critic, C, which takes as input the state and action, and outputs the expected Q-value, C(s, a)=Q. The critic model learns from the data to estimate the Q-value (expected reward) from the state given a particular next action C(s, a)=Q, and rewards what is good, and passes this information on to the actor. The actor model learns a policy that maximizes the expected Q-value from the critic, resulting in the highest reward. The value and scale of Q are dictated by the somewhat arbitrary defined rewards system. For a fixed state, s, the highest value of C(s, a) generally corresponds to the best action to take from the state.

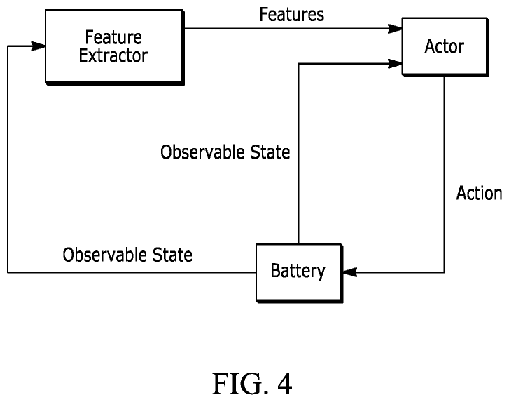

For hybrid applications—using simulation data as well as field data from real usage of vehicle batteries—the actor-critic setup can be a bit different. FIG. 4 illustrates a high-level block diagram of an actor-critic reinforcement learning model 400 that incorporates field data. During inference, e.g. operation of the vehicle, only the actor network (e.g., policy) is processing and learning. The critic's opinions are ignored at that point, and the actor policy is static. The battery management system (simulated or real) tells the actor information about the state (including the extracted long-short term memory (LSTM) features approximating the hidden states), and the actor provides the next action (charging current). In other words, the operational loop is only actor→battery. A loop of (action→battery→state→feature extractor→features→actor→action) with the skip connection of (battery→state→actor) is shown here. The critic, reward, and Q-value are not used during inference at all, only during training. In principle, the actor network is small enough that it could be operated within a vehicle during use, offline from the communication system shown in FIG. 2, for example.

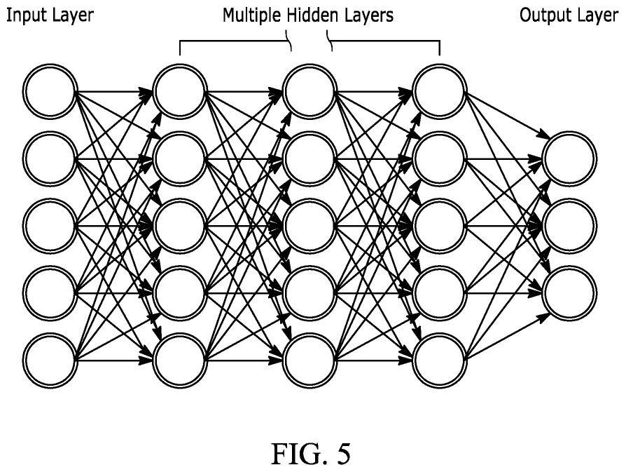

Each of the models disclosed herein can be implemented by a neural network or deep neural network (DNN), an example of which is schematically illustrated in FIG. 5. The neural network can be implemented by the one or more processors and memory disclosed herein. The illustrated network layout can be used for the actor model, the critic model, or other models configured to optimize a charging of the vehicle battery disclosed herein. The models can include an input layer (having a plurality of input nodes), a plurality of hidden layers, and an output layer (having a plurality of output nodes). The nodes of the input layer, output layer, the hidden layer(s) may be coupled to nodes of subsequent or previous layers. In a deep learning form, multiple hidden layers may be used in order to perform increasingly complex analyses; such deep learning is a subset of neural networks where the number of hidden layers is greater than one. With deep learning, these stacked hidden layers can help the system to learn by creating hierarchical representations of certain activities, where subsequently-created layers form an abstraction of previously-created layers as a way to formulate an understanding of complex correlations between the acquired data and a desired output such as a particular battery health condition (e.g., speed to full charge, other qualities described herein). And each of the nodes of the output layer may execute an activation function—e.g., a function that contributes to whether the respective nodes should be activated to provide an output of the model. The quantities of nodes shown in the input, hidden, and output layers are merely exemplary and any suitable quantities may be used.

As explained above, for a POMDP with fully-characterized states separated into an observable state and hidden state, a policy constructed accessing the full state can generally perform better than a policy constructed with just the observable states. A feature extractor is disclosed herein which is configured to learn features which are an attempt to model some of these hidden parameters. By extracting these features, the model can get a more complete state space that would be known otherwise. Using reinforcement learning described above, the “agent” comprises an actor, one or more critics, and a feature extractor. In the context of optimizing battery charging, the “environment” would be either the battery simulator or a real in-field battery. In other contexts, the “environment” can vary. Each of these systems has various inputs, outputs and update rules (e.g., learning). In the basic Markov decision process, one has an action (a), a state (s), and a reward (r). The agent and environment components include an environment (E), a feature extractor (F), an actor (A), and a critic (C). Composite components include the following:
s′, representing a next state, and where E(s, a);
f representing features, where F({sᵢ}), where {sᵢ} represents the current state and the preceding N−1 states;
f′, representing next features, where F({s′ᵢ}), where {s′ᵢ} represents the next state, the current state, and the preceding N−2 states;
a′, representing next expected actions, where A(s′,f′);
qₜᵣᵤₑ representing a cumulative reward;
q=C(s,f,a), representing the critic's expected cumulative reward; and
q′=C(s′,f′, a′), representing the critic's expected cumulative reward in the next state.

The inputs, outputs, and update rules can be summarized as follows. The environment has an input of the full state and action (s, a), and an output of the next state and reward (s′, r). The feature extractor has an input of {sᵢ} for N observable steps, an output of feature f, and critic update rules of (q+r−q)². The critic has an input of the observable state, features, action (s,f, a), an output of q, and update rules of (q+r−q′)². Note here that both q and q′ are critic predictions, and the goal is to minimize this difference. The actor has inputs of the observable state and features (s,f), an output of action a, and update rules of −q (note that a high q is deemed good, so the model tries to minimize −q.

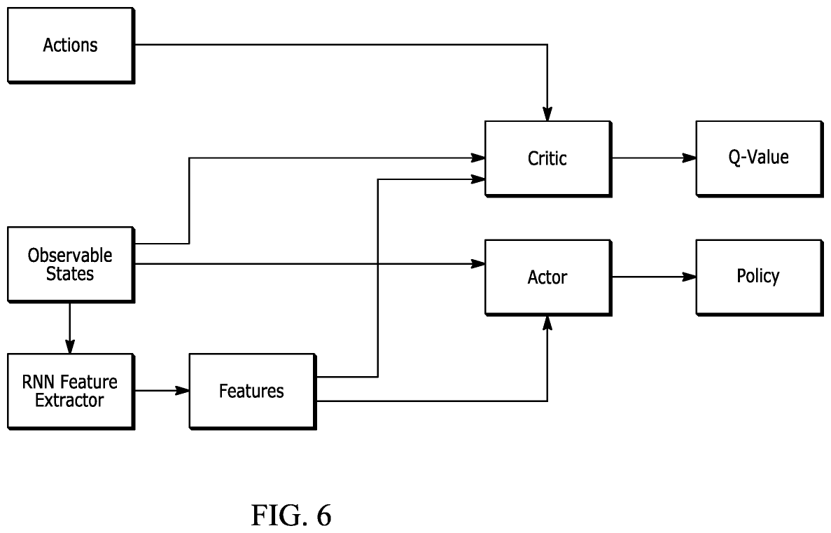

Given the above, if some of the unknown hidden state can be extracted from the history of the observable state, then a RNN (such as a long short-term memory) can partially or fully produce a set of variables that encodes the information contained in the hidden state. According to an embodiment illustrated in FIG. 6, the n preceding observable states and the current state are fed into a RNN feature extractor (or, also referred to more broadly as a sequence-processing neural network feature extractor (SPNNFE). The RNN feature extractor produces output features which are fed into the actor (along with the observable state), and into the critic (along with the observable state and the new action). The critic loss is backpropagated through the critic, and through the feature extractor in order to update the feature extractor weights. The actor only uses the result of the feature extractor and does not update the weights. In other words, referring to FIG. 6, the observable states (including N preceding) are fed into the RNN feature extractor that outputs a set of features, which are then fed into the actor and critic along with the usual required components (e.g., observable state) in order to improve the Q-value prediction and optimal policy design.

FIG. 7 illustrates a method 700 of optimizing a charging of a vehicle battery using reinforcement learning, in view of the teachings provided above. The method can be implemented by the structure of the system 200 of FIG. 2, for example. At 702, one or more electronic battery sensors are used to determine observable state data associated with charging of a vehicle battery (e.g., battery 274 of FIG. 2). The observable state data can include a battery temperature, current, voltage, or the like as disclosed above. Battery state information includes this observable battery state data as well as hidden battery state information.

At 704, a sequence-processing neural network feature extractor (SPNNFE) is used to extract features from preceding vehicle battery state information. The SPNNFE can also be referred to more generally as a feature extractor, and in some embodiments is a RNN feature extractor.

An actor-critic model can be provided, such as those described above. In particular, the actor-critic model can have an actor model configured to produce an output (e.g., policy) associated with a charge command to optimally charge the vehicle battery. The actor-critic model can also have a critic model configured to output a predicted reward. At 706, the actor-critic model is trained based on (i) the vehicle battery state information, (ii) the extracted features, and (iii) a current applied to the battery (action).

The training step at 706 can include sub-steps, illustrated at 708-712. At 708, the weights of the actor model are updated to maximize the predicted reward output by the critic model. At 710, the weights of the SPNNFE and the weights o the critic model are updated to minimize a difference between (i) the predicted reward output by the critic model and (ii) health-based rewards received from charging of the vehicle battery. At 712, at least some of the hidden battery state information is approximated based on the extracted features in order to optimize charging of the vehicle battery.

It should be understood that while FIG. 7 is directed to applying the teachings herein to optimization of a vehicle battery, the teachings disclosed herein are not limited to only such an embodiment. For example, the strategies disclosed herein for optimizing battery charging can apply to mobile phone batteries, power tool batteries, appliance batteries, lawn equipment batteries, and the like. The term “battery” should not be limited to a vehicle battery unless otherwise stated.

Moreover, the teachings disclosed herein can be applied to environments outside of batteries. For example, the disclosed feature extractor and the reinforcement learning can be applied on any POMDP scenario where only some of the information can be observed, and some of the information is hidden. For example, the feature extractor can be used in retail scenarios in which the neural networks are configured to predict when a person where shop next, where the person will shop next, and what item the person will purchase next so that a proper recommendation can be given to that person. There may be countless variables that go into these decisions made by consumers, many of which are simply unobservable and therefore can be modeled with POMDP with the disclosed feature extractor.

The teachings herein can also be used in any control application approximated by a POMDP, which can arise frequently due to incomplete state information. Specifically, the feature extractor can be used for learning a policy for controlling a physical system and then operating the physical system where some of the state is not directly observable or easily computed. For example, FIG. 8 depicts a schematic diagram of a control system 802 configured to control power tool 800, such as a power drill or driver, that has an at least partially autonomous mode. Control system 802 may be configured to control an actuator 804. Upon receipt of actuator control commands 810 by actuator 804, actuator 804 is configured to execute an action corresponding to the related actuator control command 810. Actuator 804 may include a control logic configured to transform actuator control commands 810 into a second actuator control command, which is utilized to control actuator 804. Control system 802 may receive signals 808 from an associated sensor 806, wherein the signals 808 may influence how the control system 802 controls the actuator 804. Sensor 806 of power tool 800 may be an optical sensor configured to capture one or more properties of a work surface 812 and/or a fastener 814 being driven into the work surface 812. Control system 802 may include a classifier or other model that is configured to determine a state of work surface 812 and/or fastener 814 relative to work surface 812 from one or more of the captured properties. The state may be fastener 814 being flush with work surface 812. The state may alternatively be hardness of work surface 812. Actuator 804 may be configured to control power tool 800 such that the driving function of power tool 800 is adjusted depending on the determined state of fastener 814 relative to work surface 812 or one or more captured properties of work surface 812. For example, actuator 804 may discontinue the driving function if the state of fastener 814 is flush relative to work surface 812. As another non-limiting example, actuator 804 may apply additional or less torque depending on the hardness of work surface 812. Hidden state information that may dictate whether the power tool 800 is adjusted may include a variety of factors, such as density of material of the work surface 812, temperature of the work surface 812, harness of the work surface 812, air temperature or pressure, and the like. The feature extractor may be configured to extract features and feed them into the critic model and actor model to adjust the policy of power drilling, for example, based on the teachings provided herein.

As another example, FIG. 9 depicts a schematic diagram of control system 902 configured to control automated personal assistant 900. Control system 902 may be configured to control actuator 904, which is configured to control automated personal assistant 900. Automated personal assistant 900 may be configured to control a domestic appliance, such as a washing machine, a stove, an oven, a microwave or a dishwasher. Sensor 906 may be an optical sensor and/or an audio sensor. The optical sensor may be configured to receive video images of gestures 914 of user 912. The audio sensor may be configured to receive a voice command of user 912. Control system 902 of automated personal assistant 900 may be configured to determine actuator control commands 910 configured to control system 902. Control system 902 may be configured to determine actuator control commands 910 in accordance with sensor signals 908 of sensor 906. Automated personal assistant 900 is configured to transmit sensor signals 908 to control system 902. The control system 902 may include a classifier configured to execute a gesture recognition algorithm to identify gesture 914 made by user 912, to determine appropriate actuator control commands 910, and to transmit the actuator control commands 910 to actuator 904. The control system 902 may be configured to retrieve information from non-volatile storage in response to gesture 914 and to output the retrieved information in a form suitable for reception by user 912.

It should also be understood that the scope of the invention is not limited to only actor-critic models in particular, unless otherwise stated in the claims. Instead, the teachings provided herein can apply to various forms of reinforcement models, such as on-policy reinforcement models, off-policy reinforcement models, or offline reinforcement models. In off-policy reinforcement learning models, the agent learns from the current state-action-reward information produced by the current best policy when it interacts with the environment. In off-policy reinforcement learning models, the agent learns from past experience that is stored in a replay buffer that grows as it interacts more with the environment. The state-action-reward values in the buffer do not correspond to the current best policy. In offline reinforcement models, the agent learns from past experience that is stored in a replay buffer that is static; there is no continued interaction with the environment. Offline is a special case of off-policy; an on-policy algorithm cannot be used offline.

In other embodiments, the control system may be for controlling a semi- or fully-autonomous vehicle, where hidden state information includes items of information regarding pedestrians, other vehicles, or road-specific data such as presence of potholes or faded lane lines, and the control system is configured to control (e.g., maneuver) the vehicle based on a reinforcement model that uses state information.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of optimizing a charging of a vehicle battery using reinforcement learning, the method comprising:
via one or more electronic battery sensors, determining observable battery state data associated with charging of a vehicle battery, wherein vehicle battery state information includes the observable battery state data and hidden battery state information;
via a sequence-processing neural network feature extractor (SPNNFE), extracting features from preceding vehicle battery state information;
providing a reinforcement learning model including (i) an actor model configured to produce an output associated with a charge command to charge the vehicle battery, and (ii) a critic model configured to output a predicted reward; and
training the reinforcement learning model based on (i) the vehicle battery state information, and (ii) the extracted features;
wherein the training includes:
updating weights of the actor model to maximize the predicted reward output by the critic model, and
updating weights of the SPNNFE and weights of the critic model to minimize a difference between (i) the predicted reward output by the critic model and (ii) health-based rewards received from charging of the vehicle battery; and
approximating at least some of the hidden battery state information based on the extracted features in order to optimize charging of the vehicle battery.

2. The method of claim 1, wherein the SPNNFE includes a recurrent neural network (RNN).

3. The method of claim 1, wherein the one or more electronic battery sensors includes one or more of a voltage sensor, a current sensor, and a temperature sensor.

4. The method of claim 1, wherein a loss of the critic is backpropagated through the critic and through the SPNNFE in order to modify the weights of the SPNNFE.

5. The method of claim 4, wherein during backpropagation of the actor model, the weights of the SPNNFE are not updated.

6. The method of claim 1, further comprising:
outputting a trained reinforcement learning model and a trained SPNNFE based on convergence.

7. The method of claim 1, wherein the training of the reinforcement learning model is also based upon a current applied to the battery.

8. A system for optimizing a charging of a vehicle battery using reinforcement learning, the system comprising:
one or more processors; and
memory storing instructions that, when executed by the one or more processors, cause the one or more processors to:
via one or more electronic battery sensors, determine observable battery state data associated with charging of a vehicle battery, wherein vehicle battery state information includes the observable battery state data and hidden battery state information;
via a sequence-processing neural network feature extractor (SPNNFE), extract features from preceding vehicle battery state information;
provide a reinforcement learning model including (i) an actor model configured to produce an output associated with a charge command to charge the vehicle battery, and (ii) a critic model configured to output a predicted reward;
train the reinforcement learning model based on (i) the vehicle battery state information, and (ii) the extracted features;
wherein the reinforcement learning model is trained via:
updating weights of the actor model to maximize the predicted reward output by the critic model, and
updating weights of the SPNNFE and weights of the critic model to minimize a difference between (i) the predicted reward output by the critic model and (ii) health-based rewards received from charging of the vehicle battery; and
approximating at least some of the hidden battery state information based on the extracted features in order to optimize charging of the vehicle battery.

9. The system of claim 8, wherein the SPNNFE includes a recurrent neural network (RNN).

10. The system of claim 8, wherein the one or more electronic battery sensors includes one or more of a voltage sensor, a current sensor, and a temperature sensor.

11. The system of claim 8, wherein a loss of the critic is backpropagated through the critic and through the SPNNFE in order to modify the weights of the SPNNFE.

12. The system of claim 11, wherein during backpropagation of the actor model, the weights of the SPNNFE are not updated.

13. The system of claim 8, wherein the memory stores further instructions that, when executed by the one or more processors, cause the one or more processors to:
output a trained reinforcement learning model and a trained SPNNFE based on convergence.

14. The system of claim 8, wherein the reinforcement learning model is trained based upon a current applied to the battery.

15. A method of approximating hidden state information of a reinforcement learning model, the method comprising:
via one or more electronic sensors, determining observable state information, wherein state information includes the observable state information and hidden state information;
via a recurrent neural network feature extractor (RRNFE), extracting features from preceding state information;
providing a reinforcement learning model including (i) an actor model configured to produce an output associated with a control system, and (ii) a critic model configured to output a predicted reward;
training the reinforcement learning model based on the state information and the extracted features, wherein the training includes:
updating weights of the actor model to maximize the predicted reward output by the critic model, and
updating weights of the RRNFE and weights of the critic model to minimize a difference between (i) the predicted reward output by the critic model and (ii) rewards associated with the output for the control system; and
using the trained reinforcement learning model to approximate at least some of the hidden state information based on the extracted features.

16. The method of claim 15, wherein the one or more electronic sensors include one or more electronic battery sensors configured to detect at least one of a voltage, current, and temperature of a battery.

17. The method of claim 15, wherein a loss of the critic is backpropagated through the critic and through the RRNFE in order to modify the weights of the RRNFE.

18. The method of claim 17, wherein during backpropagation of the actor model, the weights of the SPNNFE are not updated.

19. The method of claim 15, wherein the observable state information includes information associated with a state of charge of a vehicle battery.

20. The method of claim 19, wherein the updating of the weights of the actor model is made on a charge cycle-by-cycle basis of the vehicle battery.
